(19) United States
(12) Patent Application Publication
(10) Pub. No.: US 2020/0218251 A1
(43) Pub. Date: Jul. 9, 2020

(54) CONTROL METHOD FOR UNMANNED AERIAL VEHICLE, UNMANNED AERIAL VEHICLE AND MACHINE-READABLE STORAGE MEDIUM

(71) Applicant: SZ DJI TECHNOLOGY CO., LTD., Shenzhen (CN)

(72) Inventors: Jiahang YING, Shenzhen (CN); Zhaoliang PENG, Shenzhen (CN); Xia CHEN, Shenzhen (CN)

(21) Appl. No.: 16/805,312

(22) Filed: Feb. 28, 2020

Related U.S. Application Data
(63) Continuation of application No. PCT/CN2017/099610, filed on Aug. 30, 2017.

(51) Int. Cl. G05D 1/00; G05D 1/10; B64C 39/02

(52) U.S. Cl. CPC G05D 1/0016; B64C 2201/146; B64C 39/024; G05D 1/101

(57) ABSTRACT

A control method for an unmanned aerial vehicle (UAV) includes receiving a plurality of control instructions from a plurality of control devices, and executing a control operation according to the plurality of control instructions.

### CROSS-REFERENCE TO RELATED APPLICATION

This application is a continuation of International Application No. PCT/CN2017/099610, filed Aug. 30, 2017, the entire content of which is incorporated herein by reference.

### TECHNICAL FIELD

The present disclosure relates to control technology field and, more particularly, to a control method for an unmanned aerial vehicle (UAV), an unmanned aerial vehicle (UAV), and a computer-readable storage medium.

### BACKGROUND

Currently, an unmanned aerial vehicle (UAV) can be controlled by a control device. For example, the control device includes, but is not limited to, a remote controller, a smart phone, a smart wristband, or virtual reality (VR) glasses. The UAV interacts with the control device through a communication link and performs corresponding operations according to instructions from the control device.

In practical applications, the UAV cannot be communicatively linked to a plurality of control devices simultaneously. This is because when the UAV receives control instructions from the plurality of control devices simultaneously or in a same control cycle, the UAV cannot determine to which one of the control instructions it should respond, which causes the UAV to lose control.

### SUMMARY

In accordance with the disclosure, there is provided a control method for an unmanned aerial vehicle (UAV) including receiving a plurality of control instructions from a plurality of control devices, and executing a control operation according to the plurality of control instructions.

In accordance with the disclosure, there is provided a UAV including a storage memory and a processor. The storage memory stores instructions, and the processor is configured to read the instructions from the storage memory to receive a plurality of control instructions from a plurality of control devices and execute a control operation according to the plurality of control instructions.

In accordance with the disclosure, there is provided a computer readable storage medium storing instruction. When the instructions are executed by a processor, the processor is caused to receive a plurality of control instructions from a plurality of control devices and execute a control operation according to the plurality of control instructions.

### BRIEF DESCRIPTION OF THE DRAWINGS

FIG. 1 is a schematic diagram of an unmanned aerial vehicle (UAV) flight scenario according to an embodiment of the disclosure.

FIG. 2 is a schematic flowchart of a UAV control method according to an embodiment of the disclosure.

FIG. 3 is a schematic flowchart of another UAV control method according to an embodiment of the disclosure.

FIG. 4 is a schematic flowchart of another UAV control method according to an embodiment of the disclosure.

FIG. 5 is a schematic flowchart of another UAV control method according to an embodiment of the disclosure.

FIG. 6 is a schematic flowchart of another UAV control method according to an embodiment of the disclosure.

FIG. 7 is a schematic flowchart of another UAV control method according to an embodiment of the disclosure.

FIG. 8 is a schematic flowchart of another UAV control method according to an embodiment of the disclosure.

FIG. 9 is a schematic flowchart of another UAV control method according to an embodiment of the disclosure.

FIG. 10 is a schematic flowchart of another UAV control method according to an embodiment of the disclosure.

FIG. 11 is a schematic flowchart of another UAV control method according to an embodiment of the disclosure.

FIG. 12 is a schematic flowchart of another UAV control method according to an embodiment of the disclosure.

FIG. 13 is a schematic flowchart of another UAV control method according to an embodiment of the disclosure.

FIG. 14 is a schematic flowchart of another UAV control method according to an embodiment of the disclosure.

FIG. 15 is a schematic flowchart of another UAV control method according to an embodiment of the disclosure.

FIG. 16 is a schematic structural diagram of a UAV according to an embodiment of the disclosure.

### DETAILED DESCRIPTION OF THE EMBODIMENTS

Technical solutions of the present disclosure will be described with reference to the drawings of the embodiments of the disclosure. The described embodiments are only some embodiments of the disclosure not all the embodiments. Based on the embodiments of the disclosure, all other embodiments obtained by one of ordinary skill in the art without any creative effort are within the scope of the present disclosure.

Some embodiments of the disclosure are described in detail with reference to the drawings. When no conflict, the features of the embodiments and the embodiments described below can be combined with each other.

FIG. 1 is a schematic diagram of an unmanned aerial vehicle (UAV) flight scenario consistent with embodiments of the disclosure. As shown in FIG. 1, a UAV 10 is communicatively linked to a plurality of control devices. A control device may be a physical device and may include, but is not limited to, a remote joystick, a smart phone, a smart wristband, virtual reality (VR) glasses, or a remote controller. The control device may also be a virtual device virtualized by the physical device at the UAV. In some embodiments, the communication links may be wireless links or wired links. For convenient description, in the embodiments of the disclosure, only the scenario where the UAV 10 is communicatively linked to three types of control devices is shown. As shown in FIG. 1, the UAV 10 is communicatively linked to a remote controller 20 through a communication link 51, to a smart phone 30 through a communication link 52, and also to a remote joystick 40 through a communication link 53. That is, the UAV 10 can be communicatively linked to the plurality of control devices through different communication links, receive control instructions from the corresponding control devices through the respective communication links, and execute the control operation according to the control instructions.

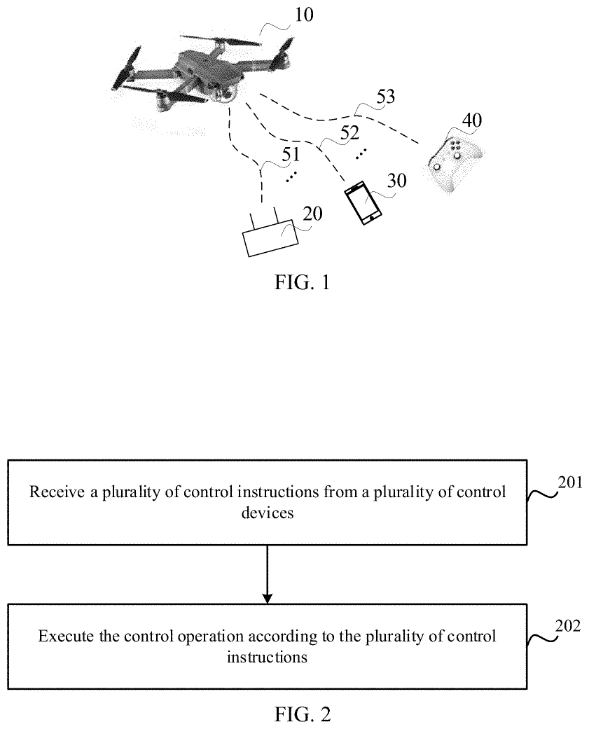

In accordance with the disclosure, there is provided a UAV control method. FIG. 2 is a schematic flowchart of a UAV control method consistent with embodiments of the disclosure. As shown in FIG. 2, the control method includes the following processes.

At 201, the plurality of control instructions are received from the plurality of control devices.

The UAV 10 can receive the plurality of control instructions at 201. As shown in FIG. 1, the UAV 10 can receive the control instructions sent by one, two, or all of the remote controller 20, the smart phone 30, or the remote joystick 40 simultaneously or in the same control cycle. That is, the control instructions may be from the plurality of control devices.

Each control instruction may include a control content, a control strength, an identification code of the control device, a communication link strength, or a communication interface, etc.

The control content refers to the effect intended to be achieved by controlling the UAV. The control content may be “fly upwards,” “fly downwards,” “fly leftwards,” “fly rightwards,” “fly forward,” “fly backward,” etc., i.e., controlling the UAV to fly upwards, fly downwards, fly leftwards, fly rightwards, fly forward, fly backward, etc. The control devices can be operated as follows to obtain the control instructions described above. Taking the remote controller as an example of the control device as for description, the left stick being pushed up indicates to control the UAV to fly upwards, the left stick being pushed down indicates to control the UAV to fly downwards, the left stick being pushed left indicates to control the UAV to turn left, or the left stick being pushed right indicates to control the UAV to turn right. Further, the right stick being pushed up indicates to control the UAV to fly forward, the right stick being pushed down indicates to control the UAV to fly backward, the right stick being pushed left indicates to control the UAV to fly leftwards, the right stick being pushed right indicates to control the UAV to fly rightwards. The control content can also be set according to specific scenarios and is not described here in detail.

The control strength refers to how fast the UAV can be controlled to achieve the desired effect. For example, the control strength may be related to the angle of the stick of the control device, or related to the duration of triggering a key, and the correlation may be linear or non-linear.

The identification code includes and is not limited to a message authentication code (MAC), an identification number, etc.

The communication link strength refers to the signal strength of the communication link between the UAV and the control device.

The control instructions may also include other contents, such as messages about communication protocols and other contents, which can be set by those skilled in the art according to a specific scenario and is not limited in the disclosure.

In some embodiments, the UAV 10 may determine the plurality of control devices according to the plurality of received control instructions. For example, the control instruction carries the identification code of the control device, and the UAV 10 can directly determine the control device according to the identification code. As another example, the UAV 10 determines the communication links that receive the plurality of control instructions, and then determines the corresponding control device of each control instruction according to matching relationship between communication links and control devices. As another example, the UAV 10 determines communication interfaces that receive the plurality of control instructions, and determines the corresponding control device of each control instruction according to the matching relationship between communication interfaces and control devices. Two or more of the methods described above can be used together to determine the control devices.

At 202, the control operation is executed according to the plurality of control instructions.

The UAV 10 executes the control operation according to the plurality of control instructions at 202.

In some embodiments, the UAV 10 first processes the plurality of control instructions, including overlapping, averaging, etc., and then executes the control operation according to the processed control instructions.

In some other embodiments, the UAV 10 first filters the plurality of control instructions, and then executes the control operation according to the filtered control instructions.

In the embodiments of the present disclosure, the situation where the UAV cannot respond to the control instructions from the plurality of control devices can be avoided. The UAV can execute the control operation according to the plurality of control instructions, so that the control efficiency is improved.

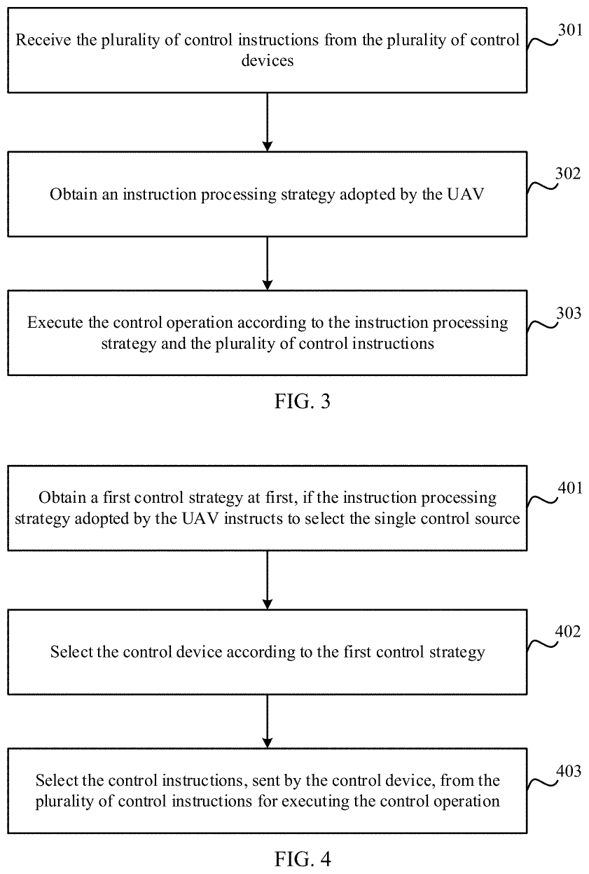

In accordance with the present disclosure, there is provided another control method for the UAV. FIG. 3 is a schematic flowchart of another UAV control method consistent with embodiments of the disclosure. As shown in FIG. 3, the control method includes the following processes.

At 301, the plurality of control instructions are received from the plurality of control devices.

The process at 301 has the same methods and principles as the process at 201, and will not be described in detail here. For detailed description thereof, reference can be made to FIG. 2 and the related content of the process at 201.

At 302, an instruction processing strategy adopted by the UAV is obtained.

The instruction processing strategy can be pre-set at the UAV. The instruction processing strategy is used to instruct the UAV 10 about how to select a control source. In embodiments of the present disclosure, the instruction processing strategy may be dynamically adjusted according to an external setting instruction. The setting instruction may be from any control device or from a designated control device. For example, the UAV receives the setting instruction sent by one of the control sources, and then adjusts priorities and/or control strategies of the plurality of control devices according to the setting instruction.

In one embodiment, the instruction processing strategy may instruct the UAV 10 to select a single control source. The single control source means that the UAV 10 is controlled by only one control device.

At 303, the control operation is executed according to the instruction processing strategy and the plurality of control instructions.

If the instruction processing strategy of the UAV 10 is to select a single control source, the process at 303 may include one of the following.

In some embodiments, as shown in FIG. 4, if the instruction processing strategy adopted by the UAV instructs to select a single control source, a first control strategy is first obtained (corresponding to the process at 401). The control device is then selected according to the first control strategy (corresponding to the process at 402). The control instructions sent by the selected control device is selected from the plurality of control instructions for executing the control operation (corresponding to the process at 403). For example, in a control cycle, the first control strategy may be to randomly select a control device as the control source, and then execute the control operation according to all the control instructions from the control device. For another example, in a control cycle, the first control strategy may be to select the control device of the first received control instruction as the control source, and then execute the control operation according to all the control instructions from the control device. For another example, in a control cycle, the first control strategy may be to select a control device of the last received control instruction as the control source, and then execute the control operation according to all the control instructions from the control device. For another example, in a control cycle, the first control strategy may be to select the control device with the strongest communication link as the control source, and then execute the control operation according to all the control instructions from the control device.

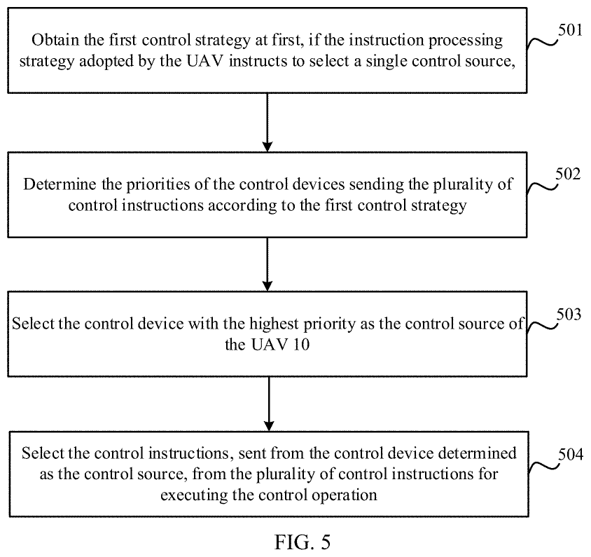

In some other embodiments, as shown in FIG. 5, if the instruction processing strategy adopted by the UAV instructs to select a single control source, the first control strategy is first obtained (corresponding to the process at 501). The priorities of the control devices sending the plurality of control instructions are then determined according to the first control strategy (corresponding to the process at 502). The control device with the highest priority is selected as the control source of the UAV 10 (corresponding to the process at 503). The control instruction sent from the control device determined as the control source is selected from the plurality of control instructions for executing the control operation (corresponding to the process at 504).

In the embodiments of the present disclosure, the plurality of control instructions are processed with the instruction processing strategy, and the control operation is executed according to the processing results. In this way, the situation where the UAV cannot respond to the control instructions of the plurality of control devices can be avoided in the present disclosure, and the UAV executes the control operation according to the plurality of control instructions, so that the control efficiency is improved.

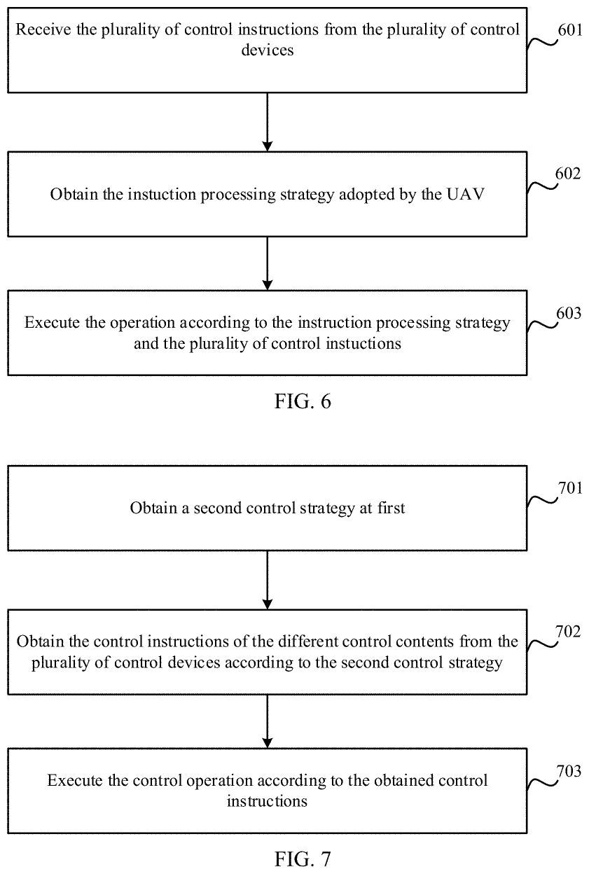

In accordance with embodiments of the present disclosure, there is provided another control method for the UAV. FIG. 6 is a schematic flowchart of another UAV control method consistent with embodiments of the disclosure. As shown in FIG. 6, the control method includes the following processes.

At 601, the plurality of control instructions are received from the plurality of control devices.

The process at 601 has the same method and principles as the process at 201, and will not be described in detail here. For detailed description thereof, reference can be made to FIG. 2 and the related content of the process at 201.

At 602, the instruction processing strategy adopted by the UAV is obtained.

The instruction processing strategy can be pre-set at the UAV 10. The instruction processing strategy is used to instruct the UAV 10 about how to select the control source. In the embodiments of the present disclosure, the instruction processing strategy may be dynamically adjusted according to an external setting instruction. For example, the UAV receives the setting instruction sent by one of the control sources, and then adjusts priorities and/or control strategies of the plurality of control devices according to the setting instruction.

In some embodiments, the instruction processing strategy can instruct the UAV 10 to select a compound control source. Selecting the compound control source means that the UAV 10 is jointly controlled by two or more control devices.

At 603, the operation is executed according to the instruction processing strategy and the plurality of control instructions.

If the instruction processing strategy adopted by the UAV instructs to select a compound control source, the plurality of control instructions can be processed according to the instruction processing strategy, and then the control operation is executed according to the processing result. In some embodiments, as shown in FIG. 7, a second control strategy is first obtained (corresponding to the process at 701). The control instructions of different control contents from the plurality of control devices are then obtained according to the second control strategy (corresponding to the process at 702). The control operation is executed according to the obtained control instructions (corresponding to the process at 703). In some embodiments, the second control strategy may be to select the control instructions from some of the control devices, to select some of the control instructions from all the control devices, or to select the control instructions corresponding to different control contents from different control devices.

Referring again to FIG. 1, the second control strategy may be to select the control instructions corresponding to the control content of “fly upwards” or “fly downwards” from the remote controller 20, to select the control instructions corresponding to the control content of “fly upwards,” “fly downwards,” “fly leftwards,” or “fly rightwards” from the smart phone 30, and to select the control instructions corresponding to the control content of “fly leftwards” or “fly rightwards” from the remote joystick 40. Those skilled in the art can select the control instructions from the other control devices according to the specific scenarios and characteristics of each control device. For example, when the control device is the virtual reality (VR) glasses, since the VR glasses are related to the range of the front view of the UAV 10, in particularly to the angle of the image acquisition device at the UAV 10, the second control strategy can be to select the control instructions from the VR glasses to control and operate the attitude of the image acquisition device at the UAV 10. For example, the attitude of a gimbal can be adjusted and controlled according to the control instructions from the VR glasses.

Based on the embodiments of FIG. 3 and FIG. 6, in a control cycle, assume that the UAV 10 receives the control instructions corresponding to the control contents of “fly upwards” and “fly rightwards,” from the remote controller 20, and also receives the control instructions corresponding to the control contents of “turn right,” “fly forward,” “fly leftwards,” and “fly downwards” from the smart phone 30. If the command control strategy of the UAV 10 is to select a compound control source, the second control strategy of the UAV is obtained, and the second control strategy is to select the control instructions corresponding to the control contents of “fly upwards,” and “fly leftwards” from the remote controller 20 and to select the control instructions corresponding to the control content “fly leftwards,” “fly downwards,” “fly forward,” and “turn right” from the smart phone 30. Thus, the control instruction corresponding to the control content of “fly upwards” from the remote controller 20 (the control instruction corresponding to “fly rightwards” is abandoned) is obtained according to the second control strategy, and at the same time the control instructions corresponding to the control contents of “fly leftwards,” “fly downwards,” “fly forward,” and “turn right” from the smart phone 30 are obtained according to the second control strategy. That is, the control instructions selected from the plurality of control instructions that conform to the second control strategy are “fly upwards,” “fly leftwards,” “fly downwards,” “fly forward,” and “turn right.” The control operation is executed according to these control instructions that conform to the second control strategy.

In the embodiments of the present disclosure, when the instruction processing strategy is to select the compound control source, the second control strategy is obtained. The compliant control instructions are selected according to the second control strategy, so that the UAV can execute the control operation according to the plurality of control instructions to improve the control efficiency and avoid the situation where the response to the control instructions of the plurality of control devices cannot be determined.

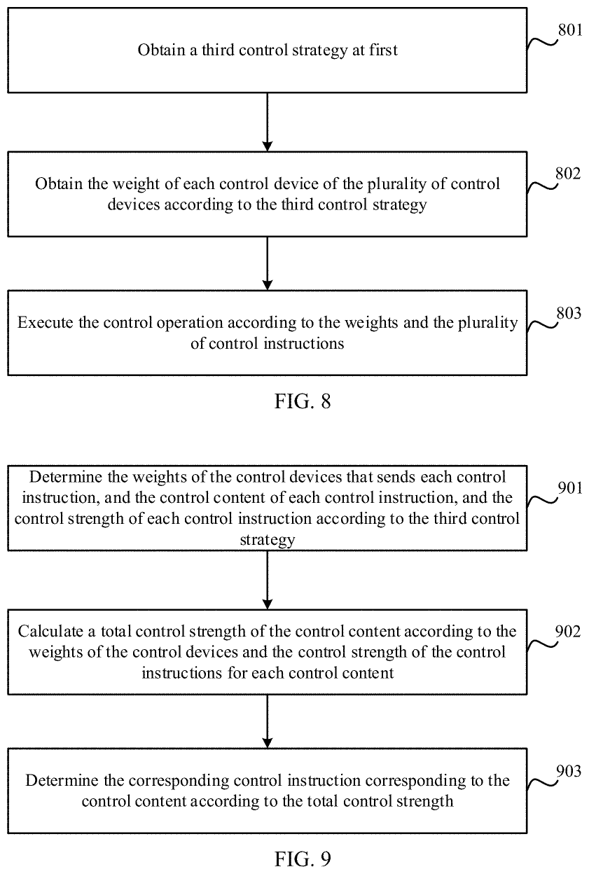

In another embodiment, with reference to FIG. 8, the process at 603 includes obtaining a third control strategy (corresponding to the process at 801), obtaining the weight of each control device of the plurality of control devices according to the third control strategy (corresponding to the process at 802), and execute the control operation according to the weights and the plurality of control instructions (corresponding to the process at 803). The weights of the control devices may be pre-set in a weight list and be configured at the UAV. The weight of the control device may also be configured during flight of the UAV or be dynamically assigned, which is not limited in the disclosure. The method for determining the control instructions according to the weights can include the following manners.

In some embodiments, as shown in FIG. 9, according to the third control strategy, the weights of the control devices that send the control instructions, the control content of each control instruction, and the control strength of each control instruction are determined (corresponding to the process at 901). According to the control contents, the plurality of control instructions are classified, and each control content corresponds to one or more of the control instructions. For each control content, a total control strength of the control content is calculated according to the weights of the control devices and the control strengths of the control instructions (corresponding to the process at 902). The corresponding control instruction corresponding to the control content is determined according to the total control strength (corresponding to the process at 903), and the UAV executes the control operation of the control instruction.

Referring again to FIG. 1, for example, the UAV 10 received the control instructions corresponding to the control contents of “fly upwards (100)” (the number in the parentheses represents the corresponding control strength, the same below) and “fly forward (80)” from the remote controller 20, received the control instructions corresponding to the control contents of “fly upwards (60)” and “fly forward (20)” from the smart phone 30, and also received the control instructions corresponding to the control contents of “fly downwards (150)” and “fly rightwards (100)” from the remote joystick 40. Assume that the weights of the remote controller 20, the smartphone 30, and the remote joystick 40 are 0.5, 0.3, and 0.2, respectively. According to the third control strategy, the plurality of control instructions can be classified as follows:

Control content “fly upwards”: “fly upwards (100),” “fly upwards (60)”;

Control content “fly downwards”: “fly downwards (150)”;

Control content “fly rightwards”: “fly rightwards (100)”;

Control content “fly forward”: “fly forward (80),” “fly forward (20).”

The total control strength of each control content can be calculated according to the weights and the control strengths as follows:

Control content “fly upwards”: 100*0.5+60*0.3=68;

Control content “fly downwards”: 150*0.2=30;

Control content “fly rightwards”: 100*0.2=20;

Control content “fly forward”: 80*0.5+20*0.3=46.

In this embodiment, the control strength is only related to the magnitude. In practical applications, the control strength can also include directions. In such case, the total control strength of each control instruction under the same control content is a vector sum. When the magnitudes and directions of the control strengths are known, the vector sum can be calculated, which will not be described here.

At least one control instruction corresponding to the same control content is determined according to the total control strength of the same control content, and the UAV executes the control operation. In this way, the UAV can receive the control instructions of all the control devices, and by assigning weights to the control devices, the control effect of each control device can be highlighted and the impact of each control device on the UAV is reduced, so that the UAV can fly evenly.

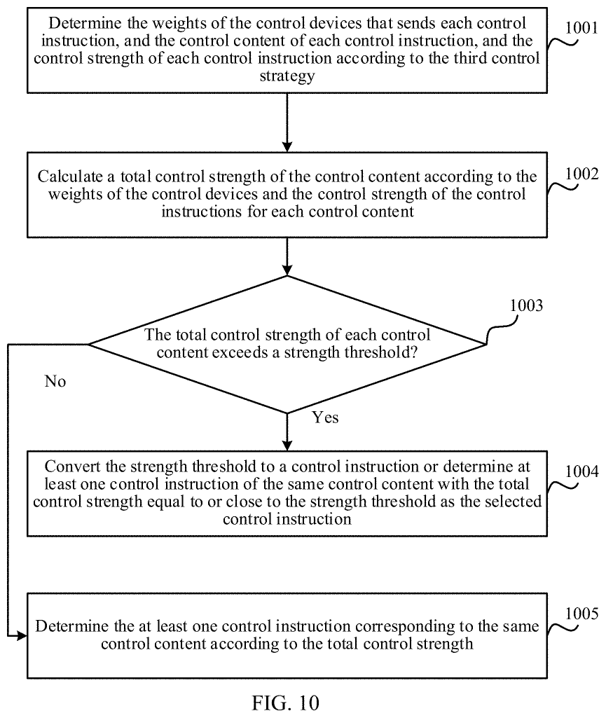

In practical applications, users who are unfamiliar with the UAV may control the UAV through the control device. In accordance with the present disclosure, there is also provided a method for protecting the UAV, as shown in FIG. 10. In the embodiments shown in FIG. 10, processes at 1001 and 1002 correspond to processes at 901 and 902 in the embodiments shown in FIG. 9, respectively, which are not described here. The method shown in FIG. 10 further includes determining whether the total control strength of each control content exceeds a strength threshold (1003). If the total control strength does not exceed the strength threshold (1003: No), the at least one control instruction corresponding to the same control content is determined according to the total control strength (1005). On the other hand, if the total control strength exceeds the strength threshold (1003: Yes), the strength threshold is converted to a control instruction or at least one control instruction of the same control content with the total control strength equal to or close to the strength threshold is determined as the selected control instruction (1004), then the UAV executes the control operation according to the control instruction. The situation where users who are unfamiliar with the UAV operate too fast or improperly to cause the UAV to malfunction can be avoided. By setting the strength threshold, the UAV can determine to respond to the plurality of control instructions and fly smoothly, so that the user experience is improved.

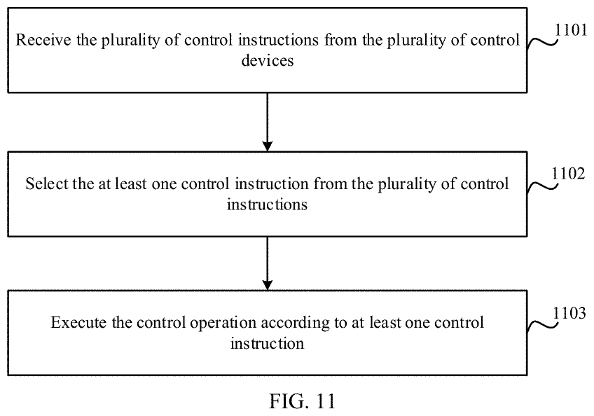

In accordance with embodiments of the present disclosure, there is provided another method for controlling the UAV. FIG. 11 is a schematic flowchart of another control method for the UAV consistent with embodiments of the disclosure. As shown in FIG. 11, the control method includes the following processes.

At 1101, the plurality of control instructions are received from the plurality of control devices.

The process at 1101 has the same method and principles as the process at 201, and will not be described in detail here. For detailed description thereof, reference can be made to FIG. 2 and the related content of the process at 201.

At 1102, at least one control instruction is selected from the plurality of control instructions.

The at least one control instruction can be selected from the plurality of control instructions according to one of the following manners.

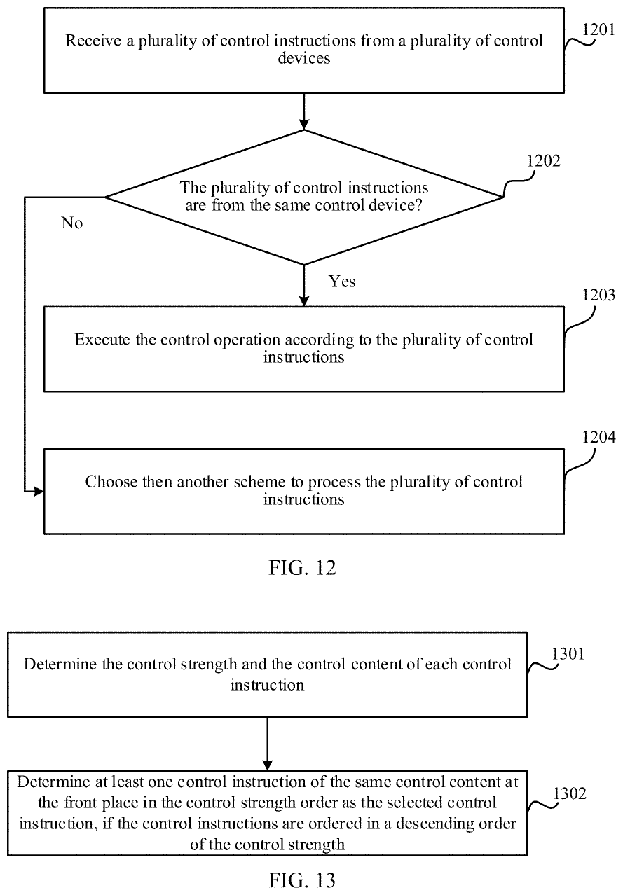

In some embodiments, as shown in FIG. 12, it is detected whether the plurality of control instructions are from the same control device (corresponding to the process at 1202), and if the control instructions are from the same control device (1202: Yes), the UAV executes the control operation according to the plurality of control instructions (corresponding to the process at 1203). The plurality of control instructions from the same control device will not cause interference to the flight of the UAV. On the other hand, if not all of the control instructions are from the same control device (1202: No), then another scheme chosen to process the plurality of control instructions (corresponding to the process at 1204), such as one of the schemes of the embodiments shown in FIG. 2 to FIG. 10 (not described here) or a scheme of the subsequent embodiments, which will be described later. For the description of the process at 1201, reference can be made to the description above of the process at 201 in FIG. 2, and the description will not be repeated here.

In some other embodiments, as shown in FIG. 13, the control strength and the control content of each control instruction are determined (corresponding to the process at 1301). Based on the control contents, the plurality of control instructions are classified, and each control content corresponds to one or more of the control instructions. For each control content, the corresponding control instructions are ordered according to the control strengths thereof. For example, if the control instructions are ordered in a descending order of the control strength, at least one control instruction of the same control content at the front place in the control strength order is determined as the selected control instruction (corresponding to the process at 1302). In some embodiments, the control instruction of the same control content at the last place in the control strength order may be determined as the selected control instruction, or the control instruction of the same control content at the middle place in the control strength order may be determined as the selected control instruction.

Referring again to FIG. 1, for example, the UAV 10 receives the control instructions corresponding to the control contents of “fly upwards (100)” and “fly forward (80)” from the remote controller 20, receives the control instructions corresponding to the control contents of “fly upwards (60)” and “fly forward (20)” from the smart phone 30, and also receives the control instructions corresponding to the control contents of “fly downwards (150)” and “fly rightwards (100)” from the remote joystick 40.

The control instructions are classified according to the control contents as follows:

Control content “fly upwards”: “fly upwards (100),” “fly upwards (60)”;

Control content “fly downwards”: “fly downwards (150)”;

Control content “fly rightwards”: “fly rightwards (100)”;

Control content “fly forward”: “fly forward (80),” “fly forward (20).”

Assume only one control instruction is selected from each control content, as follows:

Control content “fly upwards”: “fly upwards (100)”;

Control content “fly downwards”: “fly downwards (150)”;

Control content “fly rightwards”: “fly rightwards (100)”;

Control content “fly forward”: “fly forward (80).”

In this embodiment, the control strength is only related to the magnitude. In practical applications, the control strength also includes the direction. The UAV 10 performs the control operation according to the control instructions.

In some other embodiments, if the control instruction is selected only according to the magnitude of the control strength, the obtained control instruction may conflict with a current flight status of the UAV. For example, if the UAV is accelerating forward and the control instruction is selected according to the magnitude of the control strength, a control instruction of “fly forward+fly backward” may be obtained, so that there is a conflict in the change of the flight status of the UAV. Therefore, in one embodiment, a control angle of the control instruction is also determined. If the control angle matches the current flight status of the UAV (for example, if the included angle is within the range of the adjustment angle of the UAV), at least one control instruction with a stronger control strength is selected from the control instructions with matching control angles as the final control instruction. In some embodiments, the vector sum of the conflicting control instructions can be directly calculated. In some embodiments, a control instruction with a stronger control strength or a smaller control strength or matching the current flight status is selected from the conflicting control instructions for executing the control operation.

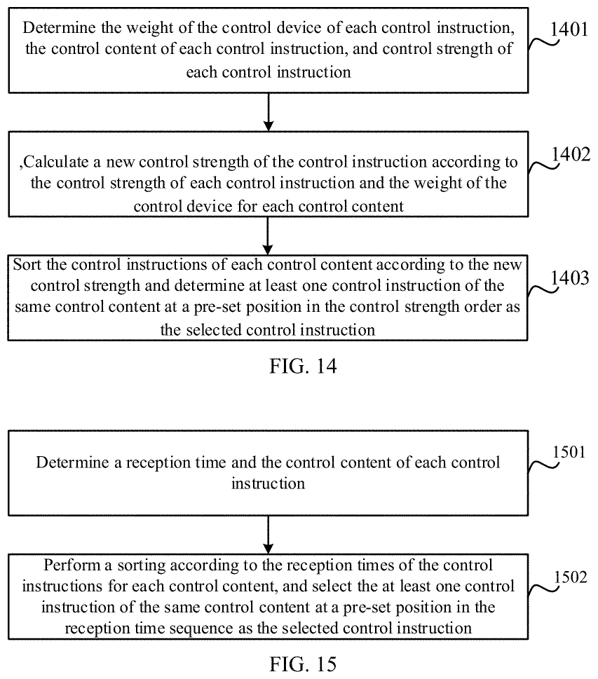

In some other embodiments, as shown in FIG. 14, the weight of the control device of each control instruction, the control content of each control instruction, and control strength of each control instruction are determined (corresponding to the process at 1401). According to the control contents, the plurality of control instructions are classified, and each control content corresponds to at least one of the control instructions. For each control content, a new control strength of the control instruction is calculated according to the control strength of each control instruction and the weight of the control device. For example, the new control strength may be the product of the control strength and the weight (corresponding to the process at 1402). The control instructions of each control content are sorted according to the new control strength, for example, in ascending order, and at least one control instruction of the same control content at a pre-set position in the control strength order is determined as the selected control instruction (corresponding to the process at 1403). In some embodiments, the control instruction of the same control content at the last position in the control strength order is determined as the selected control instruction, or the control instruction of the same control content at the middle position in the control strength order is determined as the selected control instruction.

In some other embodiments, as shown in FIG. 15, a reception time and the control content of each control instruction are determined (corresponding to the process at 1501). According to the control content, the plurality of control instructions are classified, and each control content corresponds to a part of the control instructions (e.g., one, more, etc.). For each control content, a sorting is performed according to the reception times of the control instructions, and the at least one control instruction of the same control content at a pre-set position in the reception time sequence is selected as the selected control instruction (corresponding to process at 1502). In some embodiments, a control instruction at any position in the reception time sequence can be selected to control the UAV.

At 1103, the control operation is executed according to the at least one control instruction.

The UAV executes the control operation according to the selected at least one control instruction.

In the embodiment of the present disclosure, at least one control instruction is selected from the plurality of control instructions, and the UAV execute the control operation according to the at least one control instruction to avoid a situation where the response to the control instructions of the plurality of control devices cannot be determined, which can improve the control efficiency of the UAV. In some embodiments, a plurality of users can jointly control the UAV through the plurality of control devices to improve the user experience.

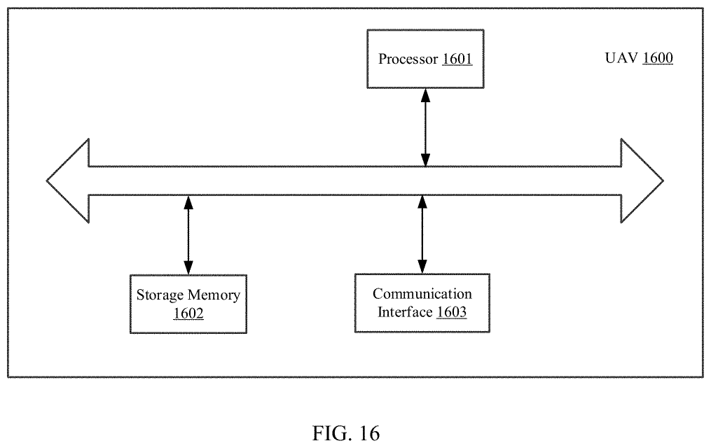

In accordance with the present disclosure, there is also provided an unmanned aerial vehicle (UAV). As shown in FIG. 16, the UAV 1600 includes a processor 1601 and a memory 1602. The memory 1602 stores several instructions. The processor 1601 is configured to read the instructions from the memory 1602 to receive a plurality of control instructions from a plurality of control devices and execute a control operation according to the plurality of control instructions.

In the embodiments of the disclosure, before the processor 1601 executes the control operation according to the plurality of control instructions, the processor 1601 obtains the instruction processing strategy adopted by the UAV and executes the control operation according to the plurality of control instructions. In some embodiments, the processor 1601 executes the control operation according to the instruction processing strategy and the plurality of control instructions.

In the embodiments of the disclosure, the processor 1601 is configured to execute the control operation according to the instruction processing strategy and the plurality of control instructions. In some embodiments, the processor 1601 obtains the first control strategy when the UAV uses the instruction of the instruction processing strategy to select the single control source and to select the control instructions from the plurality of control instructions from the control device to execute the control operation.

In some embodiments, the processor 1601 is configured to select the control device according to the first control strategy. In some embodiments, the processor 1601 determines the priorities of the control devices sending the control instructions according to the first control strategy, and selects the control device with the highest priority as the control source of the UAV.

In some embodiments, the processor 1601 executes the control operation according to the instruction processing strategy and the plurality of control instructions. For example, when the instruction processing strategy instructs the UAV to select the compound control source, the processor 1601 obtains the second control strategy, obtains the control instructions of different control contents from different control devices according to the second control strategy, and executes the control operation according to the control instructions.

In some embodiments, the processor 1601 executes the control operation according to the weights and the plurality of control instructions. For example, the processor 1601 determines the weights of the control devices of the control instructions and the control content of each control instruction, calculates the total control strength in the same control content according to the control strength of each control instruction and the weights of the control devices, determines the corresponding control instructions of the same control content according to the total control strength, and executes the control operation according to the plurality of control instructions.

In some embodiments, the processor 1601 is configured to determine the corresponding control instructions of the same control content according to the total control strength. For example, the processor 1601 determines the corresponding control instructions according to the strength threshold when the control strength exceeds the strength threshold.

In some embodiments, the processor 1601 is configured to execute the control operation according to the plurality of control instructions. For example, the processor 1601 selects at least one control instruction from the plurality of control commands and executes the control operation according to the at least one control instruction.

In some embodiments, to select the at least one control instruction from the plurality of control instructions, the processor 1601 checks whether the control devices of the plurality of control instructions are the same device, and executes the control operation according to the plurality of control instructions if the control devices are not the same.

In some embodiments, to select the at least one control instruction from the plurality of control instructions, the processor 1601 determines the control strength and control content of each control instruction, and selects at least one control instruction of the same control content at the pre-set position in the control strength order.

In some embodiments, to select the at least one control instruction from the plurality of control instructions, the processor 1601 determines the weights of the control devices sending the control instructions, the control content of each control instruction, and the control strength of each control instruction, sorts the control strength of the control instructions of the same control content in order according to the control strength and the weights of the control devices, and selects at least one control instruction of the same control content at the pre-set position in the control strength order.

In some embodiments of the disclosure, to select at least one control instruction from the plurality of control instructions, the processor 1601 determines the reception time and the control content of each control instruction, and selects at least one control instruction of the same control content at the pre-set position in the reception time sequence.

In some embodiments, the instruction processing strategy adopted by the UAV 10 is dynamically adjusted according to the external setting instruction.

In some embodiments, the processor 1601 is configured to dynamically adjust the instruction processing strategy adopted by the UAV according to the external setting instruction. For example, the processor 1601 adjusts the priorities of the plurality of control devices and/or the control strategy according to the received setting instructions from the control devices.

In some embodiments, the processor 1601 is configured to determine the plurality of control devices sending the plurality of control instructions. For example, the processor 1601 determines the communication links to receive the plurality of control instructions and determines the control devices with matching communication links as the control devices sending the control instructions.

In some embodiments, the control device includes at least one of a physical device or a virtual device virtualized by the physical device.

In some embodiments, the control device includes at least one of a remote joystick, a smart phone, a smart wristband, VR glasses, or a remote controller.

In accordance with the disclosure, there is provided a computer-readable storage medium, several computer instructions are stored in the computer-readable storage medium, the computer instructions are executed to receive the plurality of control instructions from the plurality of control devices, and to execute the control operation according to the plurality of control instructions.

In the embodiments of the disclosure, the provided processing operation of the UAV processor are described in detail, for the relevance thereof, reference can be made to the method embodiments. In some embodiments, the processing operation of the processor of the control device has been described in detail in the above control method. For the relevance thereof, reference is made to the method embodiments. In some embodiments, when the application scenario changes, the control method of the UAV will also change, and the processing operation of the processor of the UAV or of the control device will be adjusted accordingly and will not be described here.

In some embodiments, the devices and methods disclosed can be implemented in other forms. For example, the device embodiments described above are merely illustrative. The division of the units is only a logical function division, and the actual implementation may be according to another division method. For example, a plurality of units or components can be combined or integrated in another system, or some features can be omitted or not be executed. Further, the displayed or discussed mutual coupling or direct coupling or communicative connection can be through some interfaces, the indirect coupling or communicative connection of the devices or units can be electronically, mechanically, or in other forms.

The units described as separate instructions may be or may not be physically separated, the components displayed as units may be or may not be physical units, which can be in one place or be distributed to a plurality of network units. Some or all of the units can be chosen to implement the purpose of the embodiment according to the actual needs.

In the embodiments of the disclosure, individual functional units can be integrated in one processing unit, or can be individual units physically separated, or two or more units can be integrated in one unit. The integrated units above can be implemented by hardware or can be implemented by hardware and software functional unit.

The integrated units implemented by software functional units can be stored in a computer-readable storage medium. The above software functional units stored in a storage medium includes a plurality of instructions for a computing device (such as a personal computer, a server, or network device, etc.) or a processor to execute some of the operations in the embodiments of the disclosure. The storage medium includes USB drive, mobile hard disk, read-only memory (ROM), random access memory (RAM), disk or optical disk, or another medium that can store program codes.

Those of ordinary skilled in the art can understand that, for convenient and simple description, the division of individual functional units are described as an example. In actual applications, the functions above can be assigned to different functional units for implementation, i.e., the internal structure of the device can be divided into different functional units to implement all or some of the functions described above. For the specific operation process of the device described above, reference can be made to the corresponding process in the method embodiments, which will not be described in detail here.

The individual embodiments are merely used to describe the technical solution of the disclosure but not used to limit the disclosure. Although the disclosure is described in detail referring to the individual embodiments, one of ordinary skill in the art should understand that it is still possible to modify the technical solutions in the embodiments, or to replace some or all of the technical features. However, these modifications or substitutions do not cause the essence of the corresponding technical solution to depart from the scope of the technical solutions in the individual embodiments of the disclosure.

What is claimed is:

1. A control method for an unmanned aerial vehicle (UAV) comprising:
receiving a plurality of control instructions from a plurality of control devices; and
executing a control operation according to the plurality of control instructions.

2. The method of claim 1, further comprising, before executing the control operation:
obtaining an instruction processing strategy adopted by the UAV;
wherein executing the control operation includes executing the control operation according to the instruction processing strategy and the plurality of control instructions.

3. The method of claim 2, wherein:
the instruction processing strategy instructs to select a single control source; and
executing the control operation according to the instruction processing strategy and the plurality of control instructions includes:
selecting a single control device from the control devices; and
selecting one of the control instructions that is sent from the selected single control device for executing the control operation.

4. The method of claim 3, wherein selecting the single control device includes:
determining priorities of the control devices; and
selecting one of the control devices with a highest priority as the selected single control device.

5. The method of claim 2, wherein:
the instruction processing strategy instructs to select a compound control source; and
executing the control operation according to the instruction processing strategy and the plurality of control instructions includes:
obtaining the control instructions of different control contents; and
executing the control operation according to the control instructions of the different control contents.

6. The method of claim 2, wherein:
the instruction processing strategy instructs to select a compound control source; and
executing the control operation according to the instruction processing strategy and the plurality of control instructions includes:
obtaining weights of the plurality of control devices; and
executing the control operation according to the weights and the plurality of control instructions.

7. The method of claim 6, wherein executing the control operation according to the weights and the plurality of control instructions includes,
determining the weights of the control devices, and control contents and control strengths of the control instructions;
for each same control content of the control contents, calculating a total control strength according to the control strengths of the control instructions corresponding to the same control content and the weights of the control devices sending the control instructions corresponding to the control content;
determining a corresponding control instruction of the same control content according to the total control strength; and
executing the control operation according to the determined control instruction.

8. The method of claim 7, wherein determining the control instruction of the same control content according to the total control strength includes, in response to the total control strength exceeding a strength threshold, determining the corresponding control instruction according to the strength threshold.

9. The method of claim 2, wherein the instruction processing strategy is dynamically adjusted according to an external setting instruction.

10. The method of claim 9, wherein the external setting instruction instructs to adjust at least one of priorities of the plurality of control devices or a control strategy of the UAV.

11. The method of claim 1, wherein executing the control operation according to the plurality of control instructions includes:
selecting at least one control instruction from the plurality of control instructions; and
executing the control operation according to the at least one control instruction.

12. The method of claim 11, wherein selecting at least one control instruction from the plurality of control instructions includes:
determining control strengths and control contents of the control instructions; and
selecting at least one control instruction of a same control content at a pre-set position in a control strength order.

13. The method of claim 11, wherein selecting at least one control instruction from the plurality of control instructions includes:
determining weights of the control devices, and control contents and control strengths of the control instructions;
calculating a magnitude order of the control instructions of a same control content according to the control strengths of the control instructions of the same control content and the weights of the control devices sending the control instructions of the same control content; and
selecting at least one control instruction of the same control content at a pre-set position in the magnitude order.

14. The method of claim 11, wherein selecting the at least one control instruction from the plurality of control instructions includes:
determining reception times and control contents of the control instructions; and
selecting at least one control instruction of a same control content at a pre-set position in a time order.

15. The method of claim 1, further comprising:
determining the plurality of control devices sending the plurality of control instructions, including:
determining communication links that received the plurality of control instructions; and
determining control devices matching the communication links as the control devices that sent the control instructions.

16. The method of claim 1, wherein each of the control devices includes at least one of a physical device or a virtual device virtualized by the physical device.

17. The method of claim 1, wherein each of the control devices includes at least one of a remote joystick, a smart phone, a smart wristband, virtual reality (VR) glasses, or a remote controller.

18. An unmanned aerial vehicle (UAV) comprising:
a storage memory storing instructions; and
a processor configured to read the instructions from the storage memory to:
receive a plurality of control instructions from a plurality of control devices; and
execute a control operation according to the plurality of control instructions.

19. The UAV of claim 18, wherein the processor is further configured to:
obtain an instruction processing strategy adopted by the UAV before executing the control operation; and
execute the control operation according to the instruction processing strategy and the plurality of control instructions.

20. A computer readable storage medium storing instructions that, when executed by a processor, cause the processor to:
receive a plurality of control instructions from a plurality of control devices; and
execute a control operation according to the plurality of control instructions.
